(19) United States
(12) Patent Application Publication
(10) Pub. No.: US 2013/0226647 A1
(43) Pub. Date: Aug. 29, 2013

(54) INTEGRATING PROJECT PLANS INTO USER DATA STORES

(71) Applicants: Susan Chory, Seattle, WA (US); Kenneth Blaine Wolfe, Mercer Island, WA (US); Steven Roger May, Woodinville, WA (US); Mario Chenier, Woodinville, WA (US); Michael Paul Isbell, Bellevue, WA (US)

(72) Inventors: Susan Chory, Seattle, WA (US); Kenneth Blaine Wolfe, Mercer Island, WA (US); Steven Roger May, Woodinville, WA (US); Mario Chenier, Woodinville, WA (US); Michael Paul Isbell, Bellevue, WA (US)

(73) Assignee: MICROSOFT CORPORATION, Redmond, WA (US)

(21) Appl. No.: 13/403,993

(22) Filed: Feb. 24, 2012

(51) Int. Cl. G06Q 10/06

(52) U.S. Cl. 705/7.22

(57) ABSTRACT

Embodiments enable the selection and application of project plans to user data stores. A project plan having one or more project content items is created according to a pre-defined schema. The project plan is analyzed to identify the project content items that correspond to user data stores available on a computing device. The user data stores include, for example, calendar appointments, tasks, and shopping lists. The project content items are integrated with the user data stores, such as by creating calendar entries, adding tasks, and adding items to the shopping lists. A manifest is defined to describe and record the integrated project content items and the corresponding user data stores. The manifest may also be used to remove or suspend the project plan.

### BACKGROUND

Managing projects such as cooking a meal, planning a wedding, and remodeling a bathroom is difficult with existing systems. For example, managing each of the projects includes planning the steps, adjusting the plan as changes occur over time, and the completing or abandoning the project. Exemplary projects may involve shopping for items at different stores, inviting friends, sharing responsibilities, setting appointments at various times, managing a changing set of requirements and timelines, and more. Some of the existing systems are not capable of integrating content from the projects into tools that the user already has available. These systems require the user to replicate information or use multiple tools for the same task, such as having to add the items from a recipe to a weekly shopping list or having to remember to take both the weekly shopping list and the shopping list for the specific recipe when they go shopping. Further, such systems are neither capable of adapting the projects for each user based on the user's situation nor capable of handling changes (e.g., delays and updates) that may occur during project implementation. As such, without at least significant effort and diligence, information may be lost, deadlines missed, and projects may not be completed when relying on the existing systems. Additionally, some of the existing systems lack an integrated mechanism for tracking progress and motivating users toward completion of multiple active projects.

### SUMMARY

Embodiments of the disclosure integrate third party content with user data on a mobile computing device. A computing device accesses at least one project plan created according to a framework that includes a predefined schema. The project plan has one or more project content items. The accessed project plan is analyzed to identify at least one of the project content items that corresponds to at least one of a plurality of user data stores. Each of the user data stores corresponds to a user data type. The computing device integrates the identified project content items with the corresponding user data stores. A manifest is defined to describe the identified project content items and the corresponding user data stores.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating users interacting with project plans provided by plan creators.

FIG. 2 is an exemplary block diagram illustrating a computing device storing project content items integrated with user data stores.

FIG. 3 is an exemplary flow chart illustrating operation of a computing device to integrate a project plan with user data stores and create a manifest.

FIG. 4 is an exemplary user interface illustrating elements of a sample project plan.

FIG. 5 is an exemplary user interface illustrating suggestions for completing a sample project plan.

FIG. 6 is an exemplary flow chart illustrating operation of a computing device to modify a project plan based on user input.

FIG. 7 is an exemplary user interface illustrating options for modifying a project plan.

FIG. 8 is an exemplary flow chart illustrating operation of a computing device to determine a completion status of active project plans and integrate rewards based on achieved milestones.

FIG. 9 is an exemplary user interface illustrating a completion status of plurality of project plans.

FIG. 10 is an exemplary user interface illustrating activity by users participating in the same project plan.

Corresponding reference characters indicate corresponding parts throughout the drawings.

### DETAILED DESCRIPTION

Referring to the figures, embodiments of the disclosure enable the creation and management of project plans 110 integrated with user data stores 218. In some embodiments, project content items 212 associated with the project plans 110 are automatically (e.g., without manual input from a user 102) added to corresponding user data stores 218, tools, or applications 208 available to the user 102. In some embodiments, the user 102 is able to customize and/or personalize the project plans 110 to create a tailored project plan 110 that meets the needs of the user 102. For example, the user 102 may modify the project plans 110 before starting the project plans 110, or dynamically modify the project plans 110 during implementation of the project plans 110.

Aspects of the disclosure further enable the user 102 to monitor, track, and manage the progress in each of the project plans 110 anywhere at any time. The user 102 may also receive tips, updates, motivation, and rewards 216 associated with the project plans 110, as described herein. Social and community aspects are involved with the user 102 able to view and interact with friends or other contacts who are also participating in, or have participated in, the same or similar project plans 110. Aspects of the disclosure also enable plan creators 112 to brand and merchandise the project plans 110 as well as offer incentives to bring users 102 into establishments of the plan creators 112.

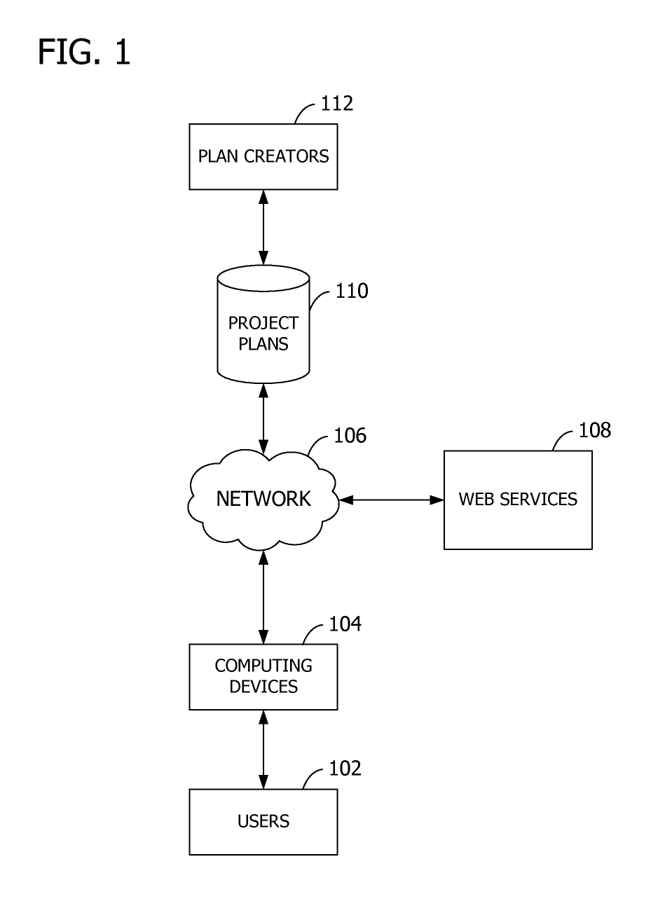

Referring next to FIG. 1, an exemplary block diagram illustrates users 102 interacting with project plans 110 provided by the plan creators 112. In the example of FIG. 1, one or more of the users 102 operate one or more computing devices 104. For example, the users 102 may access the project plans 110 from any device, and from more than one device. The computing devices 104 may communicate with web services 108 via one or more networks 106 such as the Internet. The web services 108 provide data and services to the computing devices 104 such as push data (e.g., feeds), purchase opportunities (e.g., via websites), and data storage and synchronization services, among others. For example, the computing device 104 may synchronize one or more user data stores 218 with the web service 108.

One or more plan creators 112 define project plans 110. The subject matter and content of each of the project plans 110 may vary. Exemplary project plans 110 include, but are not limited to, losing weight, raising children, home improvement such as building a deck, organizing a wedding, cooking food, preparing for a presentation, conducting a meeting, and preparing and presenting an annual budget review. Content may also include instructions (e.g., recipes, how-to's, etc.). The project plans 110 are stored in any data store and made available for download by the users 102 via the network 106. In some embodiments, the project plans 110 are stored by the web services 108. Alternatively or in addition, some of the project plans 110 may be pre-installed on the computing devices 104.

The project plans 110 are defined according to at least one pre-defined schema to enable the computing devices 104 to recognize, parse, and manipulate the project plans 110. Aspects of the disclosure are operable with any pre-defined schema understood by the computing devices 104. For example, one or more of the web services 108 may distribute or publish the pre-defined schema to both the computing devices 104 and to the plan creators 112. The computing device 104 may also publish a pre-defined schema. Alternatively or in addition, the plan creators 112 may create and distribute the pre-defined schema to the computing devices 104. For example, a definition or description of the pre-defined schema may be available for download along with the project plans 110. In this example, the computing device 104 downloads and installs the definition of the pre-defined schema to enable the computing device 104 to recognize and interpret the project plans 110 defined according to the pre-defined schema.

In some embodiments, the computing devices 104 store a plurality of project plans 110 defined according to a plurality of pre-defined schemas. In such embodiments, the computing devices 104 maintain a mapping or association between each of the project plans 110 and the corresponding pre-defined schema used to create the project plan 110.

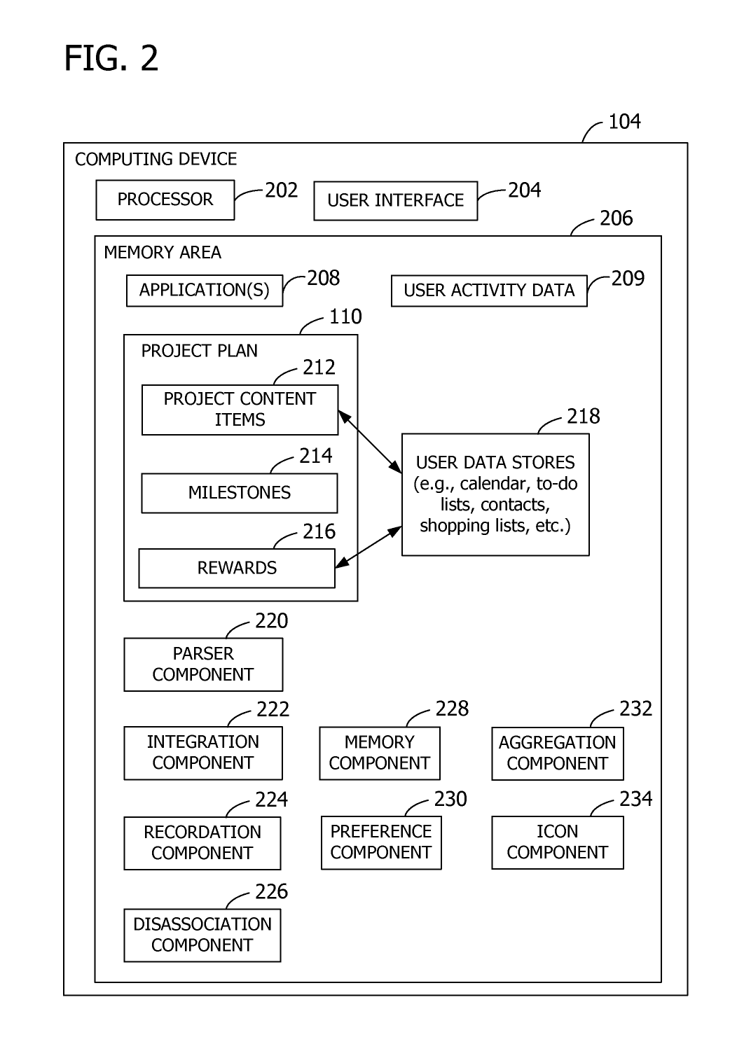

Referring next to FIG. 2, an exemplary block diagram illustrates the computing device 104 storing project content items 212 integrated with user data stores 218. In the example of FIG. 2, the computing device 104 associated with the user 102 represents a system for integrating third party content with user data on the computing device 104. The computing device 104 represents any device executing instructions (e.g., as application programs, operating system functionality, or both) to implement the operations and functionality associated with the computing device 104. The computing device 104 may include a mobile computing device or any other portable device. In some embodiments, the mobile computing device includes a mobile telephone, laptop, tablet, computing pad, netbook, gaming device, and/or portable media player. The computing device 104 may also include less portable devices such as desktop personal computers, kiosks, gaming consoles, and tabletop devices. Additionally, the computing device 104 may represent a group of processing units or other computing devices.

The computing device 104 has at least one processor 202, at least one user interface 204, and a memory area 206. The structure of the computing device 104 as described herein is merely exemplary. Aspects of the disclosure are operable with any device organized in any way to implement the methods and systems described herein. For examples, aspects of the disclosure are operable with biometric computing devices.

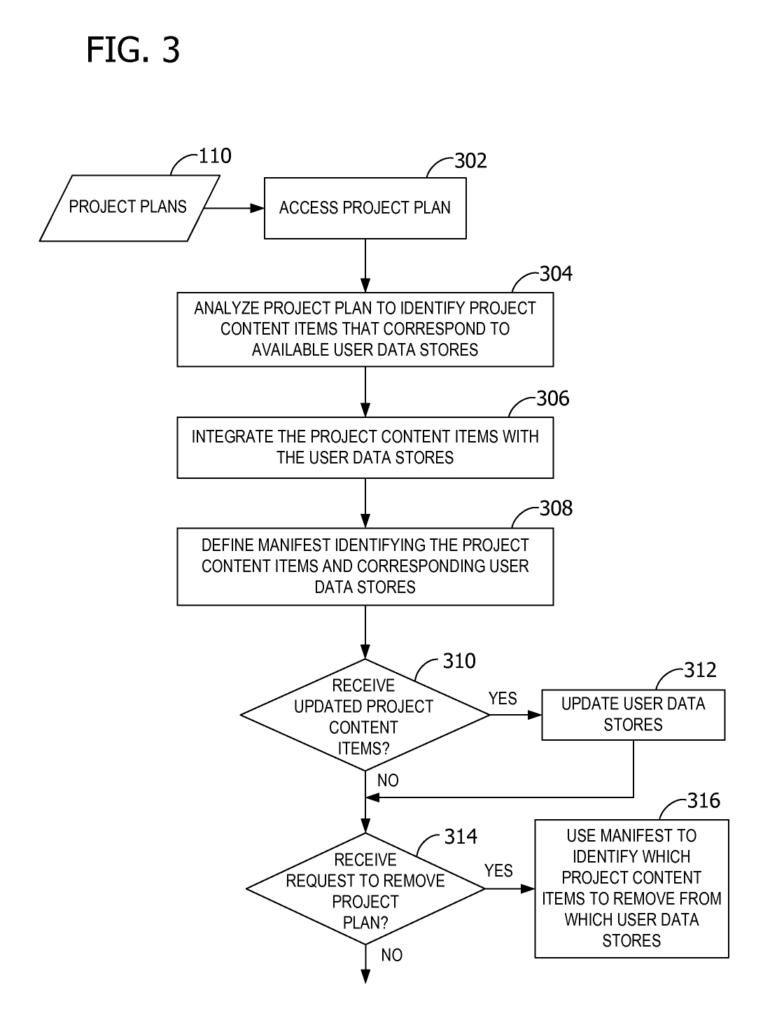

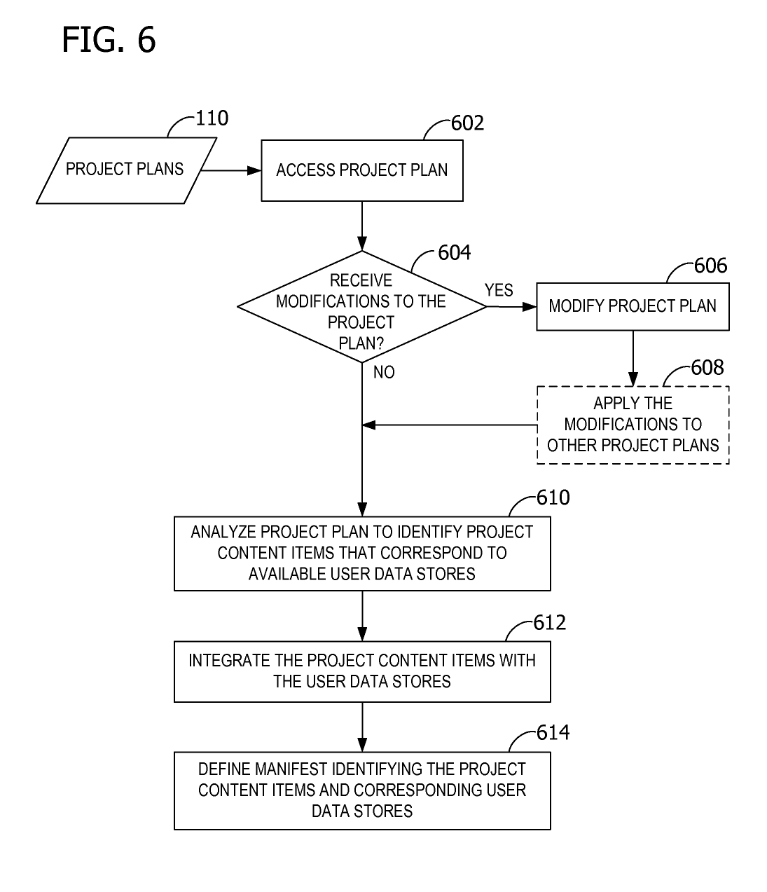

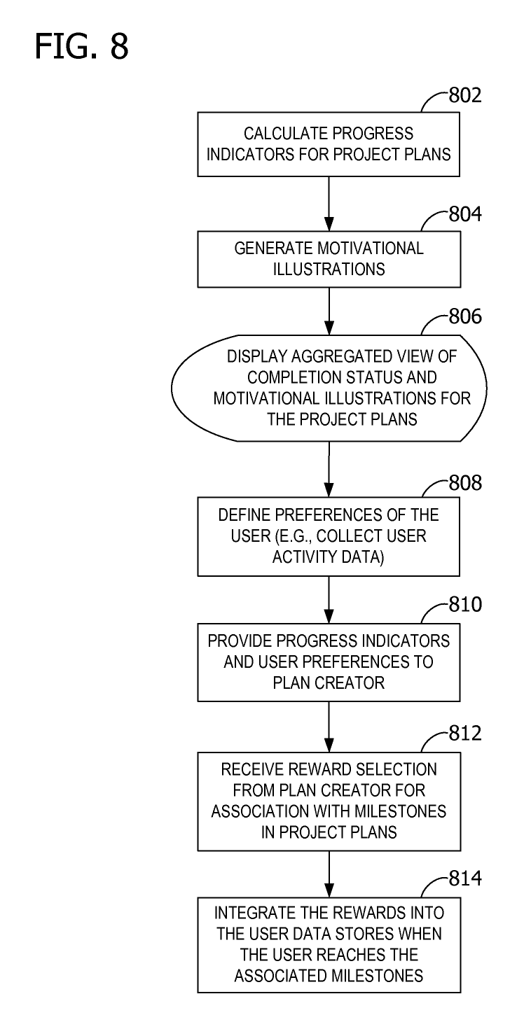

The processor 202 includes any quantity of processing units, and is programmed to execute computer-executable instructions for implementing aspects of the disclosure. The instructions may be performed by the processor 202 or by multiple processors executing within the computing device 104, or performed by a processor external to the computing device 104. In some embodiments, the processor 202 is programmed to execute instructions such as those illustrated in the figures (e.g., FIG. 3, FIG. 6, and FIG. 8).

The computing device 104 includes one or more user interfaces 204 for displaying data to the user 102 and/or receiving data from the user 102. The user interface 204 includes, for example, a touch screen display. The user interface 204 may also include computer-executable instructions (e.g., a driver) associated with a graphics card to operate the user interface 204. The user interface 204 may also include one or more of the following to provide data to the user 102 or receive data from the user 102: speakers, a sound card, a camera, a microphone, a vibration motor, one or more accelerometers, a BLUETOOTH brand communication module, and a photoreceptive light sensor. For example, the user 102 may input commands or manipulate data by moving the computing device 104 in a particular way. Further, the user interface 204 may also provide other functionality such as from a third party plugin. For example, the third party plugins may take blood pressure readings, calculate glucose levels, and obtain other data from the user 102.

In some embodiments (not shown), the computing device 104 also includes a communications interface. The communications interface enables communication between the computing device 104 and other devices and/or services. For example, the communications interface includes a network interface card and/or computer-executable instructions (e.g., a driver) for operating the network interface card. In some embodiments, the communications interface uses near-field communication (NFC) to share project plan 110 progress with other participants or users 102. The communications interface may also have a voice interface for providing audio motivation to the user 102 to complete the project plan 110 or a particular milestone 214 (e.g., the computing device 104 detects that the user 102 is on an elevator, and audibly reminds the user 102 to take the stairs for health).

The computing device 104 further has one or more computer readable media such as the memory area 206. The memory area 206 includes any quantity of media associated with or accessible by the computing device 104. The memory area 206 may be internal to the computing device 104 (as shown in FIG. 2), external to the computing device 104 (not shown), or both (not shown).

The memory area 206 stores, among other data, one or more applications 208. The applications 208, when executed by the processor 202, operate to perform functionality on the computing device 104. Exemplary applications 208 include mail application programs, web browsers, calendar application programs, address book application programs, messaging programs, media applications, location-based services, search programs, and the like. The applications 208 may communicate with counterpart or participatory applications or services such as web services 108 accessible via the network 106. For example, the applications 208 may represent downloaded client-side applications that correspond to server-side services executing in a cloud.

The memory area 206 further stores one or more of the project plans 110. Each project plan 110 has one or more project content items 212 associated therewith. The project content items 212 include, for example, one or more of the following: a task, a calendar item, audio data, video data, and image data. In some embodiments, each project plan 110 has one or more milestones 214. The milestones 214 represent progress towards completion of the project plan 110 or advancement through the project plan 110. The milestones 214 may be based on time, achievement, completion, or other properties of the project plan 110. One or more rewards 216 (e.g., reward items) may also be associated with the project plan 110. Each of the rewards 216 may be associated with one or more of the milestones 214. The rewards 216 generally include products and/or services, and may be defined by the plan creators 112 and/or the users 102. Exemplary rewards 216 include one or more of the following: free or discounted products and/or services, cash, credit, rebate, coupons, achievements (e.g., badges, limited availability electronic content), awards, and the like. The rewards 216 may further include unlocking additional project content items 212 when milestones 214 are achieved. For example, a marathon project plan may unlock a triathlon component upon completion of a marathon.

Some embodiments contemplate that the rewards 216 include negative rewards (e.g., penalties) applied when the user 102 fails to meet milestones 214 associated with the negative rewards. Exemplary negative rewards include a fee applied to a financial account of the user 102 (e.g., a credit card charge donated to a charity), or a posting to a social networking account of the user 102 to encourage friends of the user 102 to provide motivation to the user 102.

While some of the rewards 216 are described herein as being received or selected by the plan creator 112, aspects of the disclosure contemplate other entities defining the rewards 216. For example, while the plan creator 112 may offer a coupon upon completion of the project plan 110 (or meeting one of the milestones 214), the user 102 may also define a fifteen minute break to read a book as one of the rewards 216 for finishing housework.

The memory area 206 further has one or more user data stores 218. The user data stores 218 represent memory used by the application 208 or an operating system to store data associated with the user 102 (e.g., operating system data, application data, and/or user profile data). In some embodiments, each of the user data stores 218 corresponds to a user data type. For example, the user data stores 218 may include task data, calendar data (e.g., appointments), shopping list data, to-do data, reminder data, contact data, media content, and electronic mail data.

In the example of a mobile computing device, the reminder data may be triggered by the location of the mobile computing device. For example, when the user 102 enters a particular store, a reminder is triggered to remind the user 102 of shopping list items that are available from the store and associated with upcoming tasks in the project plans 110. The location may be determined in any way, such as by a global positioning system (GPS) or check-in data provided by the user 102.

After the user 102 has selected one of the project plans 110 (see FIG. 3 below), the project content items 212 are integrated with the user data stores 218. For example, any task items, calendar items, contacts, or shopping list items associated with the project plan 110 are added to a task application, calendar application, contact manager, or shopping list manager, respectively, executing on the computing device 104. An operating system or application 208 executing on the computing device 104 may perform the integration. For example, the operating system recognizes a calendar appointment defined according to the pre-defined schema and creates an appointment in a calendar of the user 102.

In some embodiments, the user interface 204 provides data stored in the memory area 206 for display to the user 102. For example, the user interface 204 may display data associated with the project content items 212 and/or the user data stores 218.

The memory area 206 also stores user activity data 209. The computing device 104 collects user activity data 209 over time. In some embodiments, the computing device 104 collects the user activity data 209 from peripherals attached or otherwise connected to the computing device 104. For example, the computing device 104 may collect blood pressure data from a blood pressure meter plugged into a universal serial bus (USB) port or connected via a BLUETOOTH wireless connection. The user activity data 209 generally includes any actions or operations performed by the user 102 that the computing device 104 is able to monitor and detect. For example, the computing device 104 monitors execution of applications 208, data sent and/or received by the computing device 104, and data input by the user 102 and/or output to the user 102. Exemplary user activity data 209 includes one or more of the following: shopping behavior, locations visited by the computing device 104 (e.g., a mobile computing device), and preferences of the user 102.

The memory area 206 further stores one or more computer-executable components. Exemplary components include a parser component 220, an integration component 222, a recordation component 224, a disassociation component 226, a memory component 228, a preference component 230, an aggregation component 232, and an illustration component 234. Operation of the computer-executable components is described below with reference to FIG. 3, FIG. 6, and FIG. 8.

Referring next to FIG. 3, an exemplary flow chart illustrates operation of the computing device 104 to integrate one of the project plans 110 with user data stores 218 and to create a manifest. While the operations illustrated in FIG. 3 are described in some embodiments as being performed by the computing device 104, one or more of the operations are capable of execution by one or more of the web services 108.

At 302, the computing device 104 accesses one of the project plans 110. For example, the computing device 104 accesses a web site or other service associated or affiliated with at least one of the plan creators 112 or other entity (e.g., a third party entity). The computing device 104 may receive the project plans 110 at any time, such as upon request by the user 102.

At 304, the computing device 104 analyzes the accessed project plan 110. For example, the computing device 104 determines the project content items 212 associated with the project plan 110, and compares the project content items 212 with the user data stores 218. As a result, the computing device 104 identifies the project content items 212 that are associated with the project plan 110 and correspond to one or more of the user data stores 218 available to the computing device 104.

At 306, the computing device 104 integrates the identified project content items 212 with the corresponding user data stores 218. In some embodiments, integrating includes adding the project content items 212 to the user data stores 218. For example, the computing device 104 integrates the project content items 212 with the user data stores 218 by updating one or more applications 208 executing on the computing device 104 with the project content items 212 (e.g., each of the applications 208 has at least one of the user data stores 218 associated therewith). In an example scenario, the computing device 104 updates a task manager application with at least one task from the project plan 110. Integration may also include calculating task or appointment due dates based on data input by the user 102 (e.g., a desired start date or end date). The computing device 104 also sets timely reminders for each of the tasks and/or appointments, in some embodiments.

At 308, the computing device 104 defines or updates a manifest or other configuration information describing the integration of the project content items 212 with the user data stores 218. The manifest is stored in any format by the computing device 104 or the web services 108. The manifest identifies the user data stores 218 to which the project content items 212 are integrated. An exemplary data structure in the manifest for a project content item 212 integrated with a user data store includes (project plan identifier, project content item identifier, user data store identifier). The exemplary data structure may further include various flags or variables indicating whether the project content item 212 has been integrated, modified, etc.

Some embodiments contemplate a single manifest reflecting the integration or application of a plurality of the project plans 110. In other embodiments, a single manifest exists for each applied project plan 110.

In some embodiments, the plan creator 112 or other entity pushes or transmits one or more updated project content items 212. For example, the plan creator 112 may modify one or more of the project content items 212 (e.g., add motivational language or a coupon offer). The plan creator 112 may update the project content items 212 based on, for example, community feedback from other users 102 or the availability of coupon offers. The project content items 212 may also be updated with social media content items (e.g., recent social networking postings), data feed updates (e.g., news, stock prices, live chats), invites (e.g., for chat requests), electronic mail messages, short message service (SMS) messages, and multimedia messaging service (MMS) messages.

If updated project content items 212 associated with an integrated (e.g., active) project plan 110 are received at 310, the computing device 104 updates the corresponding user data stores 218 at 312. For example, the computing device 104 replaces the existing project content items 212 with the corresponding updated project content items 212.

The manifest may be used to remove, uninstall, or otherwise disassociate an active or integrated project plan 110 from the computing device 104. For example, if the computing device 104 receives a request to remove the project plan 110 (e.g., from the user 102 or from the plan creator 112) at 314, the computing device 104 uses the manifest to identify the project content items 212 that are associated with the project plan 110 and integrated with the user data stores 218 at 316. The user 102 may provide the removal request, for example, upon completion of the project plan 110 or abandonment of the project plan 110. All affected user data stores 218 are updated, such as a calendar, to-do list, contact list, and shopping list. After removal of the project content items 212 from the corresponding user data stores 218, the computing device 104 updates the manifest to reflect the removal. For example, the manifest may be deleted.

Rather than removing the project plan 110, the user 102 may decide to postpone, delay, pause, or otherwise halt completion of the project plan 110. In such embodiments, the project plan 110 may be hidden from the view of the user 102 while remaining available for resumption on request by the user 102 or after a particular duration. The individual tasks associated with the project plan 110 may also be adjusted to accommodate the delay.

In some embodiments, one or more participants in a particular one of the project plans 110 may be identified to the user 102. For example, friends, contacts, or colleagues of the user 102 are identified to the user 102 by the computing device 104, web service 108, plan creator 112, or other entity. In such embodiments, the user 102 (e.g., a first user) is allowed to interact with one or more of these other participants (e.g., second users) by, for example, sending a message.

In some embodiments, one or more of the computer-executable components illustrated in FIG. 2 execute to perform one or more of the operations illustrated in FIG. 3. For example, the parser component 220, when executed by the processor 202 of the computing device 104 or a processor of one of the web services 108, causes the processor to identify at least one of the project content items 212 that corresponds to at least one of the user data stores 218. The integration component 222, when executed by the processor 202 of the computing device 104 or a processor of one of the web services 108, causes the processor to apply the project content items 212 identified by the parser component 220 to the corresponding user data stores 218. Applying the project content items 212 includes, for example, adding the project content items 212 to the corresponding user data stores 218.

In some embodiments, the integration component 222 executes to apply the project content items 212 automatically (e.g., without user input) to the corresponding user data stores 218. In other embodiments, the user 102 is prompted to manually accept one or more of the project content items 212 before the project content items 212 are added to the user data stores 218. As such, aspects of the disclosure enable the user 102 to selectively integrate portions of each project plan 110.

The recordation component 224, when executed by the processor 202 of the computing device 104 or a processor of the one of the web services 108, causes the processor to define a manifest describing the project content items 212 identified by the parser component 220 and the corresponding user data stores 218. For example, the manifest describes the mapping or corresponding between each of the project content items 212 and the corresponding user data stores 218. The recordation component 224 defines the manifest by, for example, creating a new manifest or updating an existing manifest.

The disassociation component 226, when executed by the processor 202 of the computing device 104 or a processor of one of the web services 108, causes the processor to receive a request to remove the project plan 110. In response to the received request to remove the project plan 110, the disassociation component 226 accesses the manifest to identify which project content items 212 to remove from which user data stores 218. The disassociation component 226 then removes the identified project content items 212 from the identified user data stores 218.

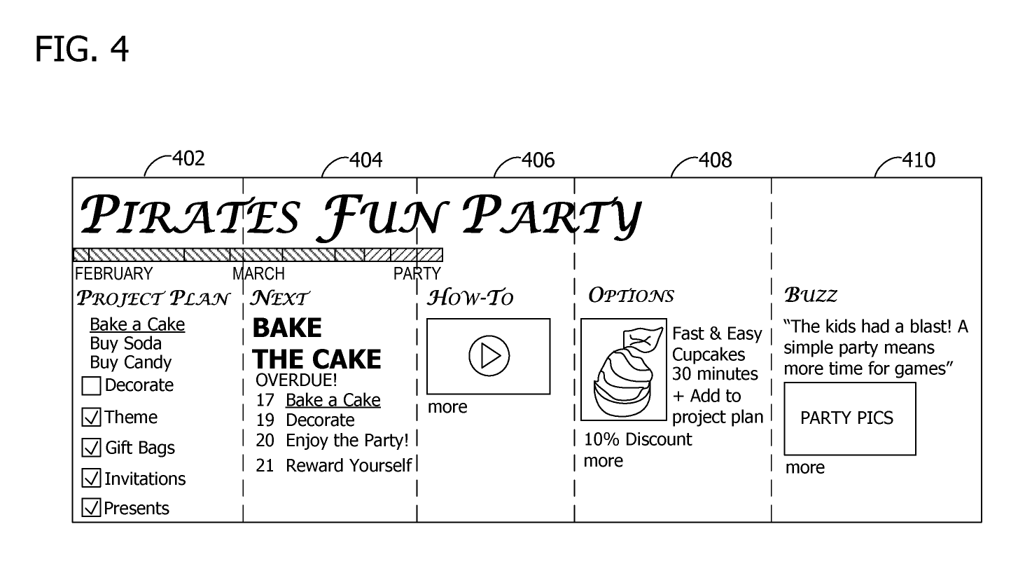

Referring next to FIG. 4, an exemplary user interface illustrates elements of a sample project plan 110. In the example of FIG. 4, vertical dashed lines define screens 402, 404, 406, 408, and 410 for display on a mobile computing device. In other examples, however, a plurality of the screens 402, 404, 406, 408, and 410 may be displayed together on a single screen (e.g., on a laptop, tablet, or other device). Further, the content and content type illustrated in FIG. 4 is merely exemplary, and variations of FIG. 4 are within the scope of the disclosure.

The example of FIG. 4 may be created, for example, by the user 102 planning a birthday party. In this example, the user 102 has searched for, and selected, a project plan 110 to help organize the birthday party using a mobile computing device. After selecting the project plan 110, the project content items 212 associated with the project plan 110 are integrated with the user data stores 218 associated with the user 102. For example, the tasks of “Bake a Cake,” “Buy Soda,” “Buy Candy,” “Decorate,” “Theme,” “Gift Bags,” “Invitations,” and “Presents” are added to a to-do list. Progress in the project plan 110 is indicated by, for example, completion of the to-do list. The user's calendar is updated with the birthday party date, along with other events and appointments such as “Bake a Cake” and “Reward Yourself” In some embodiments, overdue events are flagged or highlighted to the user 102.

The example of FIG. 4 further includes video project content items 212 such as a link to a “How-To” video (e.g., for baking a cake), project content items 212 representing options for helping the user 102 complete the project plan 110 (e.g., make cupcakes instead of a cake, a discount coupon for buying cupcakes or a cake), and project content items 212 representing social media feeds about birthday parties (e.g., comments and pictures from another birthday party). The video and audio project content items 212 may be displayed in a separate media player application, or streamed within the context of the user interface. The user 102 may also create project content items 212 by posting comments in the social media feeds section. In some embodiments, the options include advertisements for products and/or services relating to the project plan 110. Other project content items 212 may include links to audio content or to launch related applications 208 available to the user 102 (e.g., on the computing device 104).

In screen 402, the user 102 is able to mark to-do list items as complete with a checkmark in a box. The completed to-do list items may be crossed-out, grayed, or otherwise indicated as complete. Any to-do list or shopping list is also updated as complete based the receipt of the checkmark from the user 102.

In some embodiments, the user 102 is able to pin any of the project plans 110 to any screen of a mobile computing device to create easy entry points and summary data within common user interface elements. For example, the project plans 110 may be pinned to a start screen of a mobile computing device. The project plan 110 may be assigned to a tile or other icon on the start screen such that the tile is dynamically updated with project content items 212, progress indicators, or any other data associated with the project plans 110.

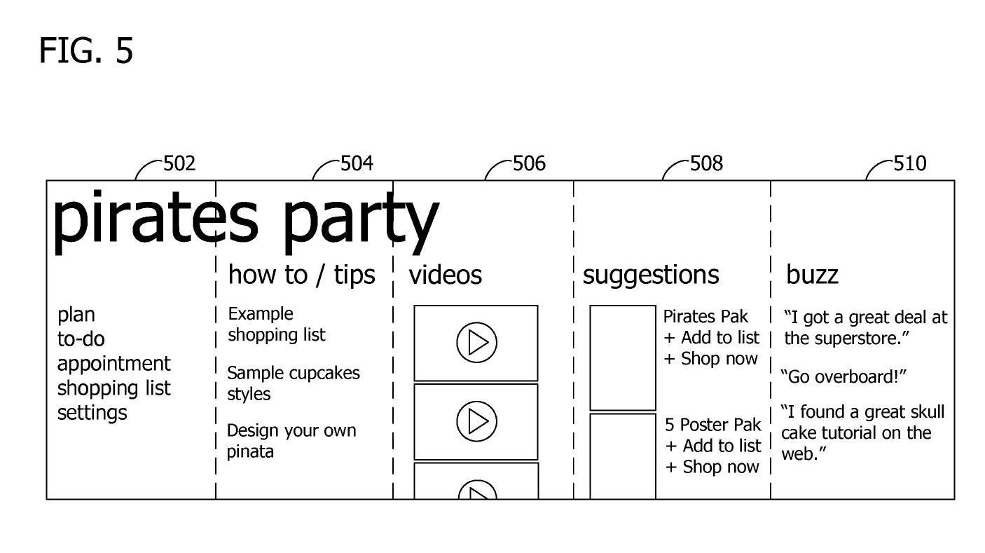

Referring next to FIG. 5, an exemplary user interface illustrates suggestions for completing a sample project plan 110. In the example of FIG. 5, vertical dashed lines define screens 502, 504, 506, 508, and 510 for display on a mobile computing device. In other examples, however, a plurality of the screens 502, 504, 506, 508, and 510 may be displayed together on a single screen (e.g., on a laptop, tablet, or other device). Further, the content and content type illustrated in FIG. 5 is merely exemplary, and variations of FIG. 5 are within the scope of the disclosure.

The example of FIG. 5 includes an alternative view of the project plan 110 in which the user 102 is presented with content relating to the subject matter of the project plan 110. For example, videos, product/service suggestions, and social media feeds are provided to the user 102. The content is selected based on the current status or progress of the user 102 with the project plan 110.

In an example involving a fitness project plan, the user interface may suggest alternative exercises (e.g., running instead of walking) if the user 102 has not progressed as far as planned. In another example, suggestions for cupcakes are presented as a shortcut to baking a cake because the user 102 is running behind schedule.

Referring next to FIG. 6, an exemplary flow chart illustrates operation of the computing device 104 to modify project plans 110 based on user input. While the operations illustrated in FIG. 6 are described in some embodiments as being performed by the computing device 104, one or more of the operations are capable of execution by one or more of the web services 108.

At 602, the computing device 104 accesses one of the project plans 110. For example, the computing device 104 accesses a web site or other service associated or affiliated with at least one of the plan creators 112 or other entity (e.g., a third party entity). The computing device 104 may receive the project plans 110 at any time, such as upon request by the user 102.

Before activation or integration of the accessed project plan 110, the computing device 104 may receive modifications to the project plan 110 at 604. For example, the plan creator 112 may provide alternative or additional project content items 212 for association with the accessed project plan 110. While reviewing the project plan 110 prior to activation or integration of the project plan 110, the user 102 may select one or more of the alternative or additional project content items 212 for inclusion with the project plan 110. The computing device 104 receives the selection from the user 102.

At 606, the computing device 104 modifies the project plan 110 based on the modifications received from the user 102. For example, the computing device 104 re-defines or regenerates the project plan 110 to include the alternative or additional project content items 212 selected by the user 102. In some embodiments, modification includes adding, replacing, and/or removing one or more project content items 212 and/or properties from the project plan 110. In other embodiments, modifying includes altering or changing one or more of the project content items 212 and/or properties. Examples of modifying the project content items 212 include, but are not limited to, one or more of the following: adding and/or removing at least task item, and adding and/or removing at least one to-do list item. Examples of modifying properties include, but are not limited to, one or more of the following: changing a start and/or end date for the project plan 110, and adjusting a timeline of the project plan 110 to accelerate or decelerate implementation of the project plan 110 (e.g., complete some of the tasks ahead of schedule or behind schedule). In another example, the goal metric may be increased (e.g., instead of losing five pounds in half the time, lose ten pounds in the original amount of time). Modifying the project plan 110 creates a customized project plan 110.

As an example, the computing device 104 merges a first plurality of project content items 212 associated with the project plan 110 with a second plurality of project content items 212 selected by the user 102. The second plurality of project content items 212 may be requested by the user 102 from the plan creator 112 or other entity (e.g., the user 102 selects an option to display additional project content items 212).

In some embodiments, the computing device 104 further applies at 608 the modifications to other project plans 110 previously selected by the user 102. In this manner, the user 102 is able to globally apply the modifications. Further, the computing device 104 may store the modifications as preferences for possible application (e.g., automatic or manual) to project plans 110 selected by the user 102 in the future.

At 610, the computing device 104 analyzes the modified project plan 110. For example, the computing device 104 determines the project content items 212 associated with the project plan 110, and compares the project content items 212 with the user data stores 218. As a result, the computing device 104 identifies the project content items 212 that are associated with the project plan 110 and correspond to one or more of the user data stores 218 available to the computing device 104.

At 612, the computing device 104 integrates the identified project content items 212 with the corresponding user data stores 218. In some embodiments, integrating includes adding the project content items 212 to the user data stores 218. For example, the computing device 104 integrates the project content items 212 with the user data stores 218 by updating one or more applications 208 executing on the computing device 104 with the project content items 212 (e.g., each of the applications 208 has at least one of the user data stores 218 associated therewith).

At 614, the computing device 104 defines or updates a manifest or other configuration information describing the integration of the project content items 212 with the user data stores 218. For example, the manifest is defined to associate an identifier of each project content item 212 with an identifier of the corresponding user data store 218.

While the project plan 110 is modified prior to integration or application of the project plan 110 with the user data stores 218 in the example of FIG. 6, aspects of the disclosure are operable with modifications to the project plan 110 while the project plan 110 is active (e.g., after or during integration). For example, the project plan 110 may be customized after the start date of the project plan 110 by updating both the manifest associated with the project plan 110 and the user data stores 218 identified in the manifest.

In some embodiments, the user 102 or computing device 104 shares the customized project plan 110 with other users 102 by transmitting the customized project plan 110 (or at least identifying the modification) to the web services 108 accessible to the other users 102. For example, the user 102 uploads the customized project plan 110 to a forum associated with a web page maintained by the plan creator 112. In another example, the user 102 can backup and restore the project plans 110, customized or non-customized, to the web services 108 and/or the plan creators 112.

In some embodiments, one or more of the computer-executable components illustrated in FIG. 2 execute to perform one or more of the operations illustrated in FIG. 6. For example, the memory component 228, when executed by the processor 202 of the computing device 104 or a processor of one of the web services 108, causes the processor to store a plurality of the project plans 110 created according to the predefined schema. Each of the project plans 110 has a manifest identifying a correspondence between the project content items 212 and one or more of the user data stores 218. The interface component, when executed by the processor 202 of the computing device 104 or a processor of one of the web services 108, causes the processor to receive, from the user 102, modifications to a first one of the project plans 110 stored by the memory component 228.

The preference component 230, when executed by the processor 202 of the computing device 104 or a processor of one of the web services 108, causes the processor to apply the modifications received by the interface component to the first one of the project plans 110. The preference component 230 further applies the modifications to a second one of the project plans 110 automatically (e.g., without user input). In some embodiments, the preference component 230 creates a template based on the received modifications and applies the created template to other active or inactive project plans 110, or to project plans 110 subsequently created by the user 102. In another example, the interface component stores the received modifications and presents the stored modifications to the user 102 as options to active project plans 110 or as options during subsequent creation of additional project plans 110 (e.g., a third one of the project plans 110).

The integration component 222, when executed by the processor 202 of the computing device 104 or a processor of one of the web services 108, causes the processor to analyze the first one of the project plans 110 to identify one or more of the project content items 212 therein that corresponds to at least one of the user data stores 218. The integration component 222 further integrates the identified project content items 212 with the corresponding user data stores 218.

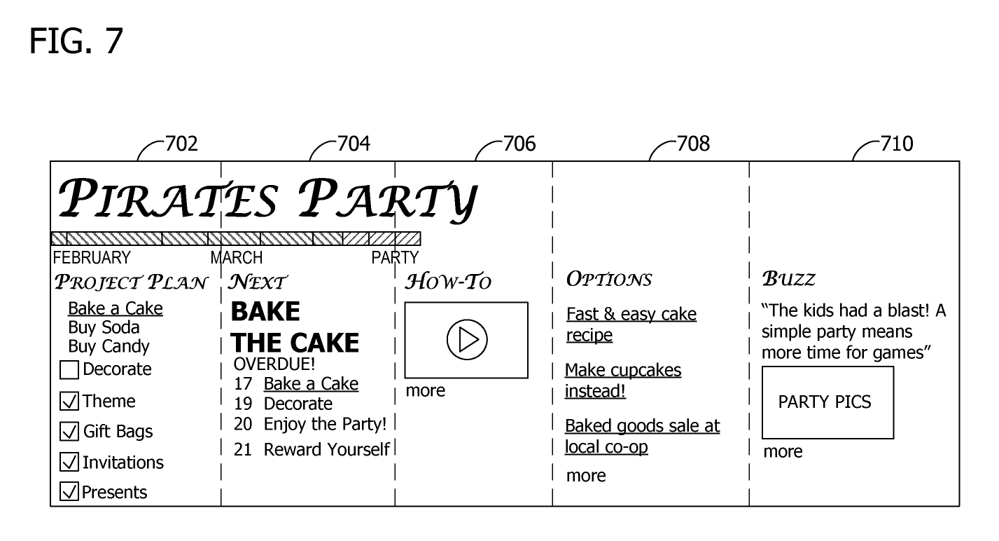

Referring next to FIG. 7, an exemplary user interface illustrates options for modifying project plans 110. In the example of FIG. 7, vertical dashed lines define screens 702, 704, 706, 708, and 710 for display on a mobile computing device. In other examples, however, a plurality of the screens 702, 704, 706, 708, and 710 may be displayed together on a single screen (e.g., on a laptop, tablet, or other device). Further, the content and content type illustrated in FIG. 7 is merely exemplary, and variations of FIG. 7 are within the scope of the disclosure.

In screen 708, the user 102 is presented with alternative project content items 212 for association with the project plan 110. For example, alternatives to baking a cake are provided such as a fast and easy cake recipe, a suggestion to make cupcakes, and a suggestion to buy baked goods from a local co-operative. In this manner, the user 102 is able to customize the project plan 110 to suit the preferences (and schedule) of the user 102.

The user 102 is further able to personalize the project plan 110 or “freestyle” off the project plan 110 by substituting project content items 212 (e.g., cookies instead of cake), deleting project content items 212 (e.g., skip the cake), and adding project content items 212 (e.g., have cookies and cake). In a fitness project plan example, the user 102 may adjust the workout frequency and/or duration while still tracking progress according to the tasks or goals in the fitness project plan.

Referring next to FIG. 8, an exemplary flow chart illustrates operation of the computing device 104 to determine a completion status of active project plans 110 and integrate rewards 216 based on achieved milestones 214. While the operations illustrated in FIG. 8 are described in some embodiments as being performed by the computing device 104, one or more of the operations are capable of execution by one or more of the web services 108.

Further, while the operations are described with reference to performance of the project plan 110 by the user 102, rewards 216 may also be earned based on completion of the project plan 110 (or portions thereof) by a plurality of cooperating users, such as for project plans 110 in which a plurality of users 102 cooperate to complete the project plans 110. In such team or cooperative project plans 110, one of the users 102 may own the project plan 110 and delegate tasks (e.g., one user 102 brings a salad to the party, another user 102 brings chips). Alternatively or in addition, the project plans 110 may represent team projects in which each of the users 102 agree to select the same project plan 110 to help motivate each other (e.g., run a marathon). In some embodiments, the project plans 110 represent co-operative projects in which none of the users 102 own the project plans 110, but multiple users 102 are needed to accomplish tasks that are integrated into a finished project. In such project plans 110, integration points are distributed across different users 102 on the team. For example, some of the shopping list items are assigned to different users 102. The rewards 216 may shared by all the users 102 on the team such as by being split evenly or unevenly across the team (e.g., based on the tasks assigned to each of the users 102).

At 802, the computing device 104 calculates a progress indicator for one or more of the project plans 110. Each progress indicator reflects a completion status of at least one of the project plans 110. The progress indicator may be any calculated using any metric or performance indicator, and is represented by a value (e.g., percentage) in some embodiments. The progress indicator may be calculated and/or represented absolutely or relatively (e.g., relative to a plurality of milestones 214 associated with the project plan 110).

At 804, the computing device 104 generates a motivational illustration for each of the project plans 110 based at least on the progress indicators. For example, the motivational illustration may include one or more icons, animations, videos, audio clips, and any other media or feedback provided to the user 102 via the computing device 104. The motivational illustrations may correspond to one or more of the rewards 216 in the active project plans 110 and/or to one or more completed project plans 110 as a reminder of past successes.

The computing device 104 displays, or provides for display, at least one of the progress indicators and/or motivational illustrations to the user 102. For example, at 806, the computing device 104 displays an aggregated view of the completion status of the active project plans 110 of the user 102 along with the generated motivational illustrations associated with each of the project plans 110.

At 808, the computing device 104 collects user activity data 209 to help define preferences of the user 102. In some embodiments, the collection of the user activity data 209 occurs over a period of time and, in some embodiments, continually re-occurs to represent a cumulative indication of user activity. In other embodiments, the collected user activity data 209 represents an instantaneous or near-instantaneous snapshot of the current user activity. Exemplary user activity data 209 includes one or more of the following: a rate of progress in one or more of the project plans 110, milestones 214 reached, rewards 216 selected and/or obtained, web browsing history, purchase history and/or behavior, applications 208 executed, mobility pattern (e.g., locations visited), and the like. Further, the user activity data 209 may be targeted to categories of interest. For example, some embodiments provide gardening suggestions based on a determined interest by the user 102 in gardening. The computing device 104 may also calculate a rate of progress or achievement with one or more of the project plans 110.

While some embodiments are described with reference to collecting the user activity data 209 to define the preferences of the user 102, other input may be used to define the user preferences. For example, the user 102 may be assigned particular preferences by the plan creator 112 or other entity.

At 810, the computing device 104 provides the calculated progress indicators and the defined user preferences (e.g., collected user activity data 209) to the plan creator 112. At 812, the computing device 104 receives a selection of at least one reward 216 from the plan creator 112. In some embodiments, the reward 216 is selected by the plan creator 112 based on the provided progress indicator and/or the user preferences (e.g., the provided user activity data 209). For example, the plan creator 112 may select the rewards 216 based on a history of the user's previous successes, the success or failure of a particular reward 216 in motivating other users 102, and/or other characteristics. Further, the computing device 104 of the user 102 may provide this reward selection functionality, rather than the plan creator 112. In this manner, the rewards 216 are customized to the user 102. The reward 216 is associated with a completion status of the project plan 110, such as the user 102 reaching or obtaining one of the milestones 214. In some embodiments, a plurality of the rewards 216 is received each for association with at least one of a plurality of the milestones 214 in the project plan 110.

At 814, the computing device 104 integrates the received reward selection into one or more of the user data stores 218 when the user 102 reaches the milestones 214 corresponding to the rewards 216. For example, when the user 102 reaches a particular milestone 214, a free or discounted reward item is offered to the user 102. In this example, the computing device 104 integrates the free or discounted reward item into a shopping list or to-do list of the user 102. In another example, the calendar of the user 102 may be updated with a spa appointment and/or a document folder or electronic wallet may be updated with an electronic coupon or credit courtesy of the plan creator 112 or sponsor. In some embodiments, frequent flyer miles may be awarded and/or gold status applied to an account of the user 102. In still another example, the reward items may include motivational messages or suggestions meant to help the user 102 make progress with the project plan 110 or meet a particular milestone 214. The reward items may also include adjustments to the properties or alterations to the user data stores 218 containing project content items 212 associated with the project plan 110. For example, the reward items may include the unlocking of new functionality in the project plan 110, adding new tasks or shopping items, increasing the skill level of the project plan 110, and/or shortening or extending a timeline of the project plan 110.

In some embodiments, the rewards 216 are identified to the user 102, prior to integration, to encourage or enticement to advance or progress towards one of the milestones 214 or completion of the project plan 110. Further, the reward items may be integrated automatically or manually. For example, when the milestones 214 associated with the reward items are met or reached, the reward items may be automatically integrated into the user data stores 218. Alternatively, the user 102 may be prompted to provide approval by accepting the reward items for integration. The user 102 may also reject the reward items.

The computing device 104 receives identification of the milestones 214 from the plan creator 112 and/or the user 102, in some embodiments. For example, each project plan 110 may have default milestones 214 associated therewith. In another example, the milestones 214 are customized to each user 102, such as being defined based on the collected user activity data 209. The user 102 may also explicitly define one or more of the milestones 214, and a sequence associated with the milestones 214. In still another example, the user 102 defines one or more of the milestones 214 via the user interface.

The reward items may be associated with completion of one or more of the milestones 214 of the project plan 110, or with completion of milestones 214 in different project plans 110. For example, a particular reward 216 may be associated with reaching Milestone A1 in Project Plan A and Milestone B1 in Project Plan B. In such an embodiment, the reward 216 may be selected based on some combination of the progress indicators for a plurality of the project plans 110. The project plans 110 may be associated with the same or different plan creators 112.

In some embodiments, one or more of the computer-executable components illustrated in FIG. 2 execute to perform one or more of the operations illustrated in FIG. 8. For example, the aggregation component 232, when executed by the processor 202 of the computing device 104 or a processor of one of the web services 108, causes the processor to calculate the progress indicators for a plurality of the project plans 110. Each of the progress indicators reflects a completion status of at least one of the plurality of project plans 110. The illustration component 234, when executed by the processor 202 of the computing device 104 or a processor of one of the web services 108, causes the processor to generate a motivational illustration for at least one of the project plans 110 based at least on the progress indicators calculated by the aggregation component 232.

The interface component, when executed by the processor 202 of the computing device 104 or a processor of one of the web services 108, causes the processor to provide the progress indicators calculated by the aggregation component 232 and the motivational illustrations generated by the illustration component 234 for display to the user 102. In some embodiments, the displayed progress indicators show the relative progress among the plurality of project plans 110 active for the user 102.

In some embodiments, the interface component further provides the user preferences and the progress indicators to the plan creators 112 for the project plans 110 and receives, from the plan creators 112, a selection of rewards 216. The rewards 216 are selected by the plan creators 112 (or plan sponsors) based on the provided user preferences and progress indicators for association with one or more of the milestones 214 in the project plans 110. In such embodiments, the reward component, when executed by the processor 202 of the computing device 104 or a processor of one of the web services 108, causes the processor to integrate at least one of the rewards 216 into one or more of the user data stores 218 when the user 102 reaches the corresponding milestones 214.

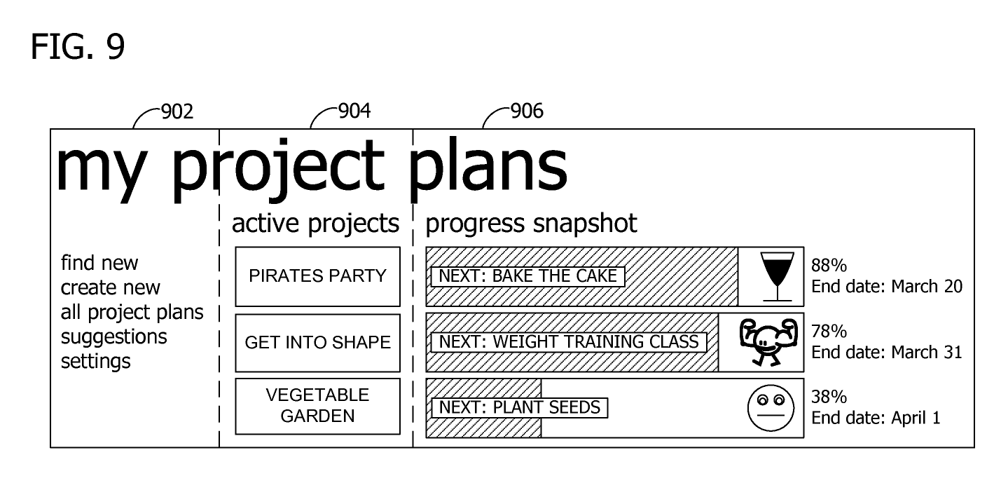

Referring next to FIG. 9, an exemplary user interface illustrates a completion status of plurality of project plans 110. In the example of FIG. 9, vertical dashed lines define screens 902, 904, and 906 for display on a mobile computing device. In other examples, the exemplary user interface is displayed on a single screen on the mobile computing device. In general, a plurality of the screens 902, 904, and 906 may be displayed together on a single screen or on multiple screens on any device (e.g., on a laptop, tablet, or other device). Further, the content and content type illustrated in FIG. 9 is merely exemplary, and variations of FIG. 9 are within the scope of the disclosure.

The exemplary user interface in FIG. 9 shows a summary of the active project plans 110 along with a completion status of each of the project plans 110. In this example, the completion status is represented by a progress indicator resembling a partially shaded rectangle or bar. With each of the progress indicators, the next task for the associated project plan 110 is displayed. Selecting any of the progress indicators opens the corresponding project plan 110 to the next task due. The end date for each project plan 110 is also displayed. In some embodiments (not shown), other milestones 214 and rewards 216 are displayed near each of the progress indicators. Further, a motivational illustration may also be displayed such as an icon performing an action, decorated with a theme, or otherwise representing characteristics associated with one of the rewards 216 and/or an end state of the project plan 110. For example, an avatar may bounce a beach ball, be decorated with a theme, or be displayed with muscles (e.g., for a fitness project plan). In another example, the motivational illustrations include photographs of the desired end state (e.g., a sandy beach) to remind the user 102 of the goal.

The user interface illustrated in FIG. 9 may also be customized by the user 102. For example, the user 102 may organize, sort, or otherwise reorder the display of the progress indicators. The user 102 may also select pie charts or other representations for the progress indicators.

In this manner, the user 102 is able to quickly monitor the progress of multiple project plans 110 by viewing each project plan 110 and the status of each of the project plans 110. The user 102 is also motivated to stay focused and advance through one or more of the project plans 110 (e.g., to achieve the rewards 216).

Screen 902 further enables the user 102 to find new project plans 110, and project plans 110 related to active project plans 110 (e.g., “suggestions”). The user 102 may also view completed milestones 214, rewards 216 obtained, and other successes in the active project plans 110, completed project plans 110, suspended project plans 110, and abandoned project plans 110.

In some embodiments (not shown), the user 102 is able to obtain an aggregated or consolidated view of project content items 212 across a plurality of the project plans 110. For example, the user 102 is able to select the plurality of the project plans 110, and then be presented with an aggregated shopping list, to-do list, and/or list of appointments (e.g., for a given time period). The user 102 may further categorize or sort the aggregated project content items 212 by plan creator 112, date of integration, project plan start date, project plan end date, and any other property.

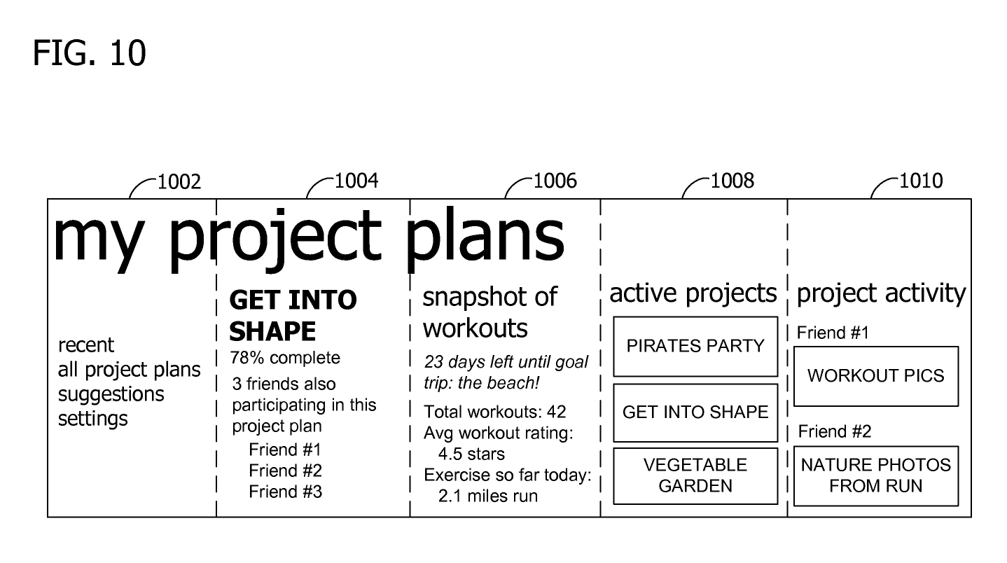

Referring next to FIG. 10, an exemplary user interface illustrates activity by users 102 participating in the same project plan 110. In the example of FIG. 10, vertical dashed lines define screens 1002, 1004, 1006, 1008, and 1010 for display on a mobile computing device. In other examples, however, a plurality of the screens 1002, 1004, 1006, 1008, and 1010 may be displayed together on a single screen (e.g., on a laptop, tablet, or other device). Further, the content and content type illustrated in FIG. 10 is merely exemplary, and variations of FIG. 10 are within the scope of the disclosure.

The user interface in FIG. 10 illustrated the ability of the user 102 to compare personal progress in the project plans 110 with the progress of other users 102 also participating in the same or similar project plans 110. For example, screen 1004 indicates that three friends of the user 102 are participating in the same fitness project plan. By selecting any of the displayed friends, the user 102 is presented with a progress indicator representing the completion status by that friend for the fitness project plan. The user 102 is further able to request help from any of the friends in completing one or more of the tasks, or view motivational messages from the friends or from the plan creator 112.

For privacy reasons, each user 102 is able to opt-in to the sharing of such information, and may limit the type, quantity, and level of details shared.

### ADDITIONAL EXAMPLES

Aspects of the disclosure enable various scenarios, some of which are next described. In an example scenario, a homeowner finds it increasingly difficult to maintain a lawn, flowerbeds, and a raised vegetable garden. While at a home improvement store, the homeowner sees a tag (e.g., a quick response code) on the product display for how to have a great lawn. The homeowner photographs an image of the tag using a mobile telephone and discovers a project plan provided by the home improvement store. The project plan provides prescriptive guidance for managing lawns and gardens, updates based on regional weather and tips from other people in the local area who are also implementing the project plan. The homeowner also receives a coupon just for downloading the project plan.

In another scenario, a young professional feels self-conscious about weight. While searching an online marketplace, the young professional finds over one hundred project plans, some of them free. The young professional selects and integrates one of the free project plans. Integration of the selected project plan includes adding a class to a calendar, establishing goals in a to-do list, and identifying rewards 216. After following the project plan and losing weight, the young professional is excited when a discount coupon to a spa is added to an electronic wallet associated with the young professional.

In another scenario, a student determines one morning that the day's schedule is light. The student checks the progress of the active project plans and quickly realizes that a reward 216 is attainable for one of the fitness project plans if the student runs just five more miles. The student decides to run the five miles today, instead of the usual two miles per day, to obtain the reward 216.

In another scenario, it is going to be a busy week for an executive. The executive maps out professional activities for the week and checks the completion status and upcoming activities associated with personal project plans. The executive decides to pause or take a break from a kitchen remodel project plan, but decides to maintain progress with a marathon training project plan. Feeling more in control of the week, the executive happily goes about the week and resumes work on the kitchen remodel project plan the following week.

At least a portion of the functionality of the various elements in FIG. 1 and/or FIG. 2 may be performed by other elements in FIG. 1 and/or FIG. 2, or an entity (e.g., processor, web service, server, application program, computing device, etc.) not shown in FIG. 1 or FIG. 2.

In some embodiments, the operations illustrated in FIG. 3, FIG. 6, and/or FIG. 8 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users 102. In such embodiments, notice is provided to the users 102 of the collection of the data (e.g., via a dialog box or preference setting) and users 102 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, tape cassettes, and cloud storage. By way of example and not limitation, computer readable media comprise computer storage media and communication media. Computer storage media include volatile and nonvolatile (e.g., persisted), removable and non-removable media implemented in any method or technology for storage of information such as computer readable instructions, data structures, program modules or other data. Computer storage media are tangible, exclude propagated data signals, and are mutually exclusive to communication media. In some embodiments, computer storage media are implemented in hardware. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well-known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for integrating third party content associated with the project plan 110 with user data on the computing device 104, exemplary means for defining the manifest to identify the project content items 212 and the corresponding user data stores 218, exemplary means for customizing the project plan 110 before integration of the project content items 212 with the user data stores 218 or after a start date of the project plan 110, exemplary means for selecting and integrating personalized rewards 216 into the project plan 110, and exemplary means for monitoring progress of a plurality of project plans 110 and providing motivational illustrations associated therewith.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for integrating third party content with user data on a mobile computing device, said system comprising:
a memory area associated with a mobile computing device of a user, said memory area storing at least one project plan created according to a predefined schema, the project plan having one or more project content items associated therewith, the memory area further storing a plurality of user data stores each corresponding to a user data type; and
a processor programmed to:
analyze the project plan stored in the memory area to identify at least one of the project content items that corresponds to at least one of the plurality of user data stores;
integrate the identified at least one of the project content items with the at least one of the plurality of user data stores;
define a manifest describing the identified at least one of the project content items and the at least one of the plurality of user data stores;
receive one or more updated project content items associated with the project plan; and
update one or more of the plurality of user data stores based on the received, updated project content items.

2. The system of claim 1, wherein the project content items comprise one or more of the following: a task, a contact, a calendar item, audio data, video data, and image data.

3. The system of claim 1, wherein the plurality of user data stores corresponds to one or more of the following: user profile data, operating system data, and/or application data.

4. The system of claim 1, wherein the plurality of user data stores comprises one or more of the following: task data, calendar data, contact data, shopping list data, to-do data, reminder data, and electronic mail data.

5. The system of claim 1, further comprising a user interface providing one or more of the following to the user: the identified at least one of the project content item, and the at least one of the plurality of user data stores.

6. The system of claim 1, wherein the processor is further programmed to synchronize one or more of the user data stores with a web service.

7. The system of claim 1, wherein the processor is further programmed to receive the one or more updated project content items by receiving one or more of the following:
a social media content item, a feed content item, and a chat request.

8. The system of claim 1, further comprising means for integrating third party content associated with the project plan with user data on a computing device.

9. The system of claim 1, further comprising means for defining the manifest to identify the project content items and the corresponding user data stores.

10. A method comprising:
accessing, by a computing device, at least one project plan created according to a predefined schema, the project plan having one or more project content items associated therewith;
analyzing the accessed project plan to identify at least one of the project content items that corresponds to at least one of a plurality of user data stores, each of the plurality of user data stores corresponding to a user data type;
integrating, by the computing device, the identified at least one of the project content items with the at least one of the plurality of user data stores; and
defining a manifest describing the identified at least one of the project content items and the at least one of the plurality of user data stores.

11. The method of claim 10, wherein said accessing, said analyzing, said integrating, and said defining are performed by a web service.

12. The method of claim 10, wherein integrating the identified at least one of the project content items comprises updating an application with the identified at least one of the project content items, the application being associated with the at least one of the plurality of user data stores.

13. The method of claim 10, wherein integrating the identified at least one of the project content items comprises updating a task manager application with at least one task associated with the project plan.

14. The method of claim 10, further comprising:
publishing the predefined schema for access by a third party entity; and
receiving the at least one project plan from the third party entity.

15. The method of claim 10, further comprising:
identifying, to a first user, a second user participating in the project plan; and
allowing the first user to interact with the second user.

16. The method of claim 10, further comprising dynamically updating one or more of the identified at least one of the project content items after integration of the project plan.

17. One or more computer storage media embodying computer-executable components, said components comprising:
a parser component that when executed causes at least one processor to identify at least one of a plurality of project content items that corresponds to at least one of a plurality of user data stores, the plurality of project content items being associated with a project plan, each of the plurality of user data stores corresponding to a user data type;
an integration component that when executed causes at least one processor to apply the at least one of the plurality of project content items identified by the parser component to the at least one of the plurality of user data stores;
a recordation component that when executed causes at least one processor to define a manifest describing the at least one of the plurality of project content items identified by the parser component and the at least one of the plurality of user data stores; and
a disassociation component that when executed causes at least one processor to receive a request to remove the project plan and to remove, based on the manifest defined by the recordation component, the identified at least one of the plurality of project content items from the at least one of the plurality of user data stores.

18. The computer storage media of claim 17, wherein the recordation component defines the manifest by creating or updating the manifest.

19. The computer storage media of claim 17, wherein the integration component applies the at least one of the plurality of project content items identified by the parser component by applying, without user input, the at least one of the plurality of project content items identified by the parser component to the at least one of the plurality of user data stores.

20. The computer storage media of claim 17, wherein the disassociation component receives the request to remove the project plan by updating the manifest to indicate that the project plan has been abandoned or postponed.
